(19) United States
(12) Patent Application Publication
(10) Pub. No.: US 2006/0140398 A1
(43) Pub. Date: Jun. 29, 2006

(54) Method for defence against differential power analysis attacks

(76) Inventor: Roberto Avanzi, Herne (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/559,767

(22) PCT Filed: Jun. 1, 2004
(86) PCT No.: PCT/IB04/50813

§ 371 Date: Mar. 16, 2006

(30) Foreign Application Priority Data
Jun. 12, 2003 (EP) 03101718.9

(51) Int. Cl. H04L 9/30

(52) U.S. Cl. 380/30

(57) ABSTRACT

In order to refine a method for defence against at least one attack made by means of differential power analysis on at least one hyperelliptic cryptosystem, in particular at least one hyperelliptic public key cryptosystem, which is given by at least one hyperelliptic curve (C) of any genus (g) over a finite field (K) in a first group, where the hyperelliptic curve (C) is given by at least one co-efficient, so that an essential contribution can be made towards an efficient and secure implementation of the hyperelliptic cryptosystem, it is proposed that the hyperelliptic curve (C) and/or at least one element of the first group, in particular at least one in particular reduced divisor and/or at least one intermediate result of a scalar multiplication, is randomised.

The present invention relates to a method for defence against at least one attack which is made by means of differential power analysis in at least one hyperelliptic cryptosystem, in particular in at least one hyperelliptic public key cryptosystem, which is given by at least one hyperelliptic curve of any genus over a finite field in a first group, where the hyperelliptic curve is given by at least one co-efficient.

Although until recently elliptic cryptosystems (=systems based on E[lliptic] C[urve] C[ryptography]) were considered faster than hyperelliptic cryptosystems (=systems based on H[yperelliptic] C[urve) C[ryptography]), even in the past the use of Jacobian variations of hyperelliptic curves over finite bodies was proposed as an alternative to elliptic curves for cryptography (see Neal Koblitz, “A family of Jacobians suitable for discrete log cryptosystems”, in S. Goldwasser (Ed.), “Advances in Cryptology—CRYPTO '88”, Vol. 403 of “Lecture Notes in Computer Science”, Pages 94 to 99, 21st to 25 Aug. 1988, Springer-Verlag, 1990; Neal Koblitz, “Hyperelliptic Cryptosystems”, Journal of Cryptology 1 (1989), Pages 139 to 150).

Two more recent developments however now show that the view that ECC systems were faster than HEC systems should be changed:

In September 2002, Kim Nguyen (Philips Semiconductors) presented the results of his implementation of Tanja Lange' projective formulae (see Tanja Lange, “Inversion-Free Arithmetic on Genus 2 Hyperelliptic Curves”, Cryptology ePrint Archive, Report 2002/147, 2002, http://eprint.iacr.org/) in genus 2 on an experimental hardware simulator at ECC 2002 “Workshop on elliptic curve cryptography” in Essen. The results suggest the competitiveness of HEC.

Shortly afterwards J. Peizi, T. Wollinger, J. Guajardo and C. Paar described highly efficient formulae for genus 3 curves (J. Pelzl, T. Wollinger, J. Guajardo, C. Paar, “Hyperelliptic Curve Cryptosystems: Closing the Performance Gap to Elliptic Curves”), including a drastic improvement of the doubling times in one important case and implementation on an “embedded microprocessor” (ARM7).

With the efficient implementation of HEC-based systems on hardware, in particular on chip cards, the question arises directly of the security of HEC in relation to differential power analysis. Differential power analysis was introduced by P. Kocher, J. Jaffe and B. Jun in two works (see. P. Kocher, J. Jaffe and B. Jun, “Introduction to Differential Power Analysis and Related Attacks”, http://www.cryptography.com/dpa/technical, 1998; P. Kocher, J. Jaffe and B. Jun, “Differential Power Analysis”, Lecture Notes in Computer Science, Vol. 1666, Pages 388 to 397, Springer-Verlag, Berlin, Heidelberg, 1999) and is described in the cited works.

Brief descriptions of differential power analysis are also given in

sections 3.2 and 3.3 of the work by M. Joye and C. Tymen, “Protection against Differential Analysis for Elliptic Curve Cryptography—An Algebraic Approach” in C. K. Koc, D. Naccache and C. Paar (Ed.): CHES 2001, “Lecture Notes in Computer Science”, Vol. 2162, Pages 377 to 390, Springer-Verlag, Berlin, Heidelberg, 2001 or

section 3 of the work by J.-S. Coron, “Resistance against Differential Power Analysis for Elliptic Curve Cryptosystems” in C. K. Koc and C. Paar (Ed.): CHES '99, “Lecture Notes in Computer Science”, Vol. 1717, Pages 292 to 302, Springer-Verlag, Berlin, Heidelberg, 1999.

Such DPA attacks measure the current consumption of cryptographic apparatus during processing of various inputs and set the measurements in correlation with the values of defined bits in the internal representation of data. The idea of differential power analysis is however very general and also functions with further physical values e.g. electromagnetic radiation.

The previous depictions for implementation of HEC-based cryptosystems were mainly focussed on the efficiency of implementation and neglected-the resistance of implementation to attacks by means of differential power analysis.

Starting from the above disadvantages and inadequacies, and with an assessment of the outlined state of the art, the present invention is based on the object of refining a method of the type cited initially so that an essential contribution can be made towards an efficient and secure implementation of systems based on hyperelliptic cryptography.

This object is achieved by a method with the features given in claim 1. Advantageous embodiments and suitable refinements of the present invention are characterised in the sub-claims.

The present invention is thus based on the principle of providing counter-measures for defence against attacks based on differential power analysis in the implementation of hyperelliptic cryptosystems, and in particular in that scalar multiplication on the Jacobian variation of a hyperelliptic curve is made resistant to differential power analysis by curve randomisation (in the sense of a hyperelliptic analogon of randomisation of curves in the work cited above by M. Joye and C. Tymen) and/or by divisor randomisation (in the sense of a hyperelliptic analogon of the third counter-measure of the work cited above by J.-S. Coron: Randomisation of points—here divisor randomisation).

In this way the invention described makes an essential contribution towards efficient and secure implementation of h[yperelliptic] c[urve] c[ryptography]-based systems i.e. in the direction of robustness and security of HEC-based cryptosystems against such DPA attacks, where in addition to the techniques and feasibility, the complexity of such methods will also be considered below.

The basic concept of curve randomisation is to modify the bits of the operand in an unforeseeable way. To this end the desired calculation is performed not in the given group but in a second group, randomly generated but isomorphic; the result is then related back to the first group.

The basic concept of divisor randomisation is to modify the bits of the depiction of a reduced divisor, which is normally the base element of the cryptosystem or an intermediate result of scalar multiplication. The technique of divisor randomisation can be used whenever a group element can be depicted in several different ways.

The present invention relates to furthermore a microprocessor working according to a method of the type described above.

The present invention further relates to a device, in particular a chip card and/or in particular a smart card, having at least one microprocessor according to the type described above.

The present invention finally relates to the use of:

a method according to the type described above and/or

at least one microprocessor according to the type described above and/or

at least one device, in particular at least one chip card and/or in particular at least one smart card, according to the type described above,

in the defence of at least one attack made by means of differential power analysis on at least one hyperelliptic cryptosystem, in particular on at least one hyperelliptic public key cryptosystem; here a public key cryptosystem normally uses an asymmetric encryption method.

As already described above, there are various ways of structuring and refining the teaching of the present invention advantageously. For this reference is made to the claims following from claim 1.

The invention will be further described with reference to examples of embodiments shown in the drawing to which however the invention is not restricted.

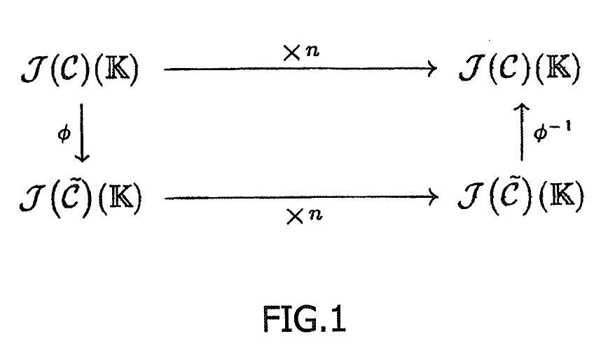

FIG. 1 shows diagrammatically an embodiment example of a method according to the present invention based on a principle of curve randomisation.

Before explaining the method of curve randomisation below on the basis of a first embodiment example, for an application-oriented introduction to the theory of hyperelliptic curves reference is made to “A. Menezes, Y.-H. Wu and R. Zuccherato, “An Elementary Introduction to Hyperelliptic Curves”, Appendix in Neal Koblitz, “Algebraic aspects of cryptography”, Algorithms and Computations in Mathematics, Vol. 3, pages 155 to 178, Springer-Verlag, 1998.

The notation used below deviates from this work by following the notation according to:

Tanja Lange, “Inversion-Free Arithmetic on Genus 2 Hyperelliptic Curves”, Cryptology ePrint Archive, Report 2002/147, 2002, http://eprint.iacr.org/,

Tanja Lange, “Weighted Co-ordinates on Genus 2 Hyperelliptic Curves”, Cryptology ePrint Archive, Report 2002/153, 2002, http://eprint.iacr.org/, and

J. Pelzl, T. Wollinger, J. Guajardo, C. Paar, “Hyperelliptic Curve Cryptosystems: Closing the Performance Gap to Elliptic Curves”.

Starting from two hyperelliptic curves C, \tilde{C} of genus g≧1 over the finite field K, a K-isomorphism φ: C→\tilde{C} can clearly be expanded into a K-isomorphism of the Jacobian variation φ: J(C)→J(\tilde{C}). Instead of calculating Q=nD in J(C)(K), where n is a natural number and D an element of J(C)(K), then
Q=φ¹(nφ(D)) (1)

is executed.

This means in other words that the diagram in FIG. 1 is commutative and that in this diagram according to the invention the longer route via J(\tilde{C})(K) is taken (the reference “x n” in FIG. 1 means “multiplied with n”).

In this context the counter-measure implemented by this K-isomorphism of the Jacobian variations to protect against attacks made on the basis of differential power analysis is particularly successful if the depictions of the co-efficients of curve C and the elements of J(C)(K) differ greatly from the depictions of the images under φ. This can for example be achieved by multiplication of all operands with random figures.

The description below shows not only that this is possible, but also that only a few field operations are required for this.

One practical implementation of the principle outlined above of curve randomisation by means of general isomorphism of curves first assumes that

g≧1 is a natural figure

K is a finite field and

C, \tilde{C} are hyperelliptic curves of genus g, which are defined by Weierstraβ equations
C: y²+h(x)y−f(x)=0 (2)
C: y²+\tilde{h}(x)y−\tilde{f}(x)=0 (3)

over the field K where

the polynomial f, \tilde{f} are standardised by degree 2g+1 in x and

h(x), \tilde{h}(x) has maximum degree g.

The hyperelliptic curve C (like the hyperelliptic curve \tilde{C}) has no singular affine points i.e. there are no pairs (x, y)ε K×K, which simultaneously fulfil the equation y²+h(x)y−f(x)=0 and the partially derived equations 2y+h(x)=0 and h′(x)y−f′(x)=0. An equivalent condition is that the discriminant 4f(x)+h(x)² does not vanish (see Theorem 1.7 from P. Lockhart, “On the discriminant of a hyperelliptic curve”, Trans. Amer. Math. Soc. 342 (1994), No. 2, Pages 729 to 752, MR 94f:11054). Similar conditions apply to \tilde{C}.

The non-affine point of the projective completion of C (or \tilde{C}) is known as “infinite”. All K-curve isomorphisms φ: C→\tilde{C} can be described by variable transformation of the form
φ: (x, y) [symbol] (s²x+b, s-^{-(2g+1)}y+A(x)) (4)

(see Proposition 1.2 from P. Lockhart, “On the discriminant of a hyperelliptic curve”, Trans. Amer. Math. Soc. 342 (1994), No. 2, Pages 729 to 752, MR 94f:11054), for suitable s ε K^{x}, b ε K and A(x)ε K[x] of degree≦g.

If x or y in equation (3) can be replaced by s⁻²x +b or s^{-(2g+1)}y+A(x), by comparison with equation (2) it can be concluded that

$$\{ \begin{matrix}h ( x ) = {s}^{2 g + 1} ( \tilde{h} ( {s}^{- 2} x + b ) + 2 A ( x ) ) \\ f ( x ) = {s}^{2 ( 2 g + 1 )} ( \tilde{f} ( {s}^{- 2} x + b ) - {A ( x )}^{2} - \tilde{h} ( {s}^{- 2} x + b ) A ( x ) ) .\end{matrix} \qquad ( 5 )$$

The inverse transformation is

$$\{ \begin{matrix}\tilde{h} ( x ) = {s}^{- ( 2 g + 1 )} h ( \hat{x} ) - 2 A ( \hat{x} ) \\ \tilde{f} ( x ) = {s}^{- 2 ( 2 g + 1 )} f ( \hat{x} ) + {s}^{- ( 2 g + 1 )} h ( \hat{x} ) A ( \hat{x} ) - {A ( \hat{x} )}^{2} \\ where \hat{x} = {s}^{2} ( x - b ) .\end{matrix} \qquad ( 6 )$$

The isomorphism feature φ: C→\tilde{C} induces an isomorphism of group variations φ: J(C)→J(\tilde{C}). The Jacobian variation of a curve C is canonically isomorphic to the ideal class group Cl⁰(C), which is more suitable for explicit calculations; consequently it must be found how φ operates as function Cl⁰(C)→Cl⁰(\tilde{C}).

It should be noted here that in D. Cantor, “Computing in the Jacobian of a hyperelliptic curve”, Mathematics of Computation, 48 (1987), Pages 95 to 101, algorithms were developed for the calculations in the ideal class group with the depiction in D. Mumford, “Tata Lectures on Theta II”, Birkhuser, 1984 which are outlined briefly below:

Let D be the sole main divisor of degree≦g in a given divisor class to C, i.e. D=Σ_{PεS}m_{P}P−(Σ_{PεS}m_{P})_{infinite},

where the finite point set S is a part set of C(K) and is designated as a carrier of D and

where the multiples ml are positive integers with Σ_{PεS}m_{P}≦g.

Then the ideal class belonging to main divisor D is given by a pair of clearly defined polynomials U(t), V(t) ε K[t] with the following properties:

$$g \geq {deg}_{t} U \geq {deg}_{t} V , U is standardised and 〈 \begin{matrix}U ( t ) = {∐}_{P ɛ S} {( t - {x}_{p} )}^{mp} \\ V ( {x}_{p} ) = yp for all P ɛ \\ U ( t ) divides V ( t ) 2 + V ( t ) h ( t ) - f ( t )\end{matrix} \qquad ( 7 )$$

According to the following nomenclature [U(t), V(t)] depict the reduced divisor D.

The aim is to find two polynomials Ü(t), \ddot{V}(t) ε K[t] which have similar properties U(t), V(t) but belong to divisor φ(D)=Σ_{PεS}m_{P}φ(P)−(Σ_{PεS}m_{P})_{infinite} to C instead D. In other words this means that for all field extensions L/K the following relations apply:

$$D = {\sum }_{P ∈ S} {m}_{P} P - ( {\sum }_{P ∈ S} {m}_{P} ) ∞ {⟶}^{ϕ} {\sum }_{P ∈ S} {m}_{P} ϕ ( P ) - ( {\sum }_{P ∈ S} {m}_{P} ) ∞ = ϕ ( D )$$

$$‖ ‖ \\ [ U ( t ) , V ( t ) ] {⟶}^{ϕ} [ \tilde{U} ( t ) , \tilde{V} ( t ) ]$$

It is clear how the desired polynomials must be constructed. Clearly:

$$\begin{matrix}\tilde{U} ( t ) = {\prod }_{P ∈ S} {( t - {x}_{ϕ ( P )} )}^{{m}_{P}} \\ = {\prod }_{P ∈ S} {( t - {s}^{- 2} {x}_{P} - b )}^{{m}_{P}} \\ = {s}^{- 2 {\sum }_{P ∈ S} {m}_{P}} U ( {s}^{2} ( t - b ) ) \\ = {s}^{- 2 {deg}_{t} U} U ( {s}^{2} ( t - b ) ) .\end{matrix} \qquad ( 8 )$$

Furthermore \tilde{V}(x_{100 (P)})=y_{φ(P)} for all P ε S, i.e.
\tilde{V}(s⁻²x_{P}+b)=s^{-(2g+1)}y_{P}+A(x_{P})=s^{-(2g+1)}V(x_{P})+A(x_{P}).

A suitable candidate is
\tilde{V}(t)=s^{-(2g+1)}V(s²(t−h))+A(s²(t−b)) (9)

In fact equation (8) and equation (9) give the correct answer; this is due to the unambiguity of the depiction of a reduced divisor: Ũ(t) and \tilde{V}(t) are defined over K, deg\tilde{V}=degV<degU=degŨ and the finding that Ũ(t) in fact divides \tilde{V}(t)²+\tilde{V}(t)\tilde{h}(t)−\tilde{f}(t) is easy.

The case is now considered below where K is a field of uneven characteristic.

It is assumed that h(x)=\tilde{h}(x)=0, then the defining equations with the variable transformation according to y→y−h(x)/2 and y→y−h(x)/2 can always be brought into this form. The advantage is that the Cantor algorithm runs much more quickly and for the same reason explicit formulae in uneven characteristic were developed under the above assumption The equations for C, \tilde{C} are
C: y²−f(x)=0 (10)
\tilde{C}: y²−\tilde{f}(x)=0. (11)

This means in equation (6), that A(x)=0.

If char K≠2g+1 then furthermore it can be assumed that the co-efficient f_{2g} (and that in \tilde{f}(x)) belonging to the second highest power of (x) in \tilde{f}(x) vanishes as a variable transformation according x→x −f_{2g}/(2g+1) can always be carried out. In this case by virtue of equation (6), necessarily b=0 .

Thus φ is of the type
φ: (x, y) [symbol] (s⁻²x, s^{-(2g+1)}y)
with s ε K^{x}. With regard to the uneven characteristic, only isomorphisms of this type need to be considered, even if char K=2g+1. The formula for \tilde{f} is then
\tilde{f}(x)=s^{-2(2g+1)}f(x²x).

This randomisation changes all coefficients of the Weierstraβ equation and the two polynomials representing the reduced divisor (excluding those hard-wired at 1), namely
Ũ(t)=s^{-2deg}^{ₜ}^{U}U(s²t), \tilde{V}(t)=s^{-(2g+1)}V(s²x).

Consequently this randomisation can be considered a secure counter-measure for defence against attacks based on differential power analysis in implementations of hyperelliptic cryptosystems with a field K of uneven characteristic.

In an explicit description of this very rapid curve can randomisation achieved by means of an implementatory trick, with a field K of uneven characteristic first a random element s ε K^{x} is selected and then its multiplicative inverse calculated. This is because s⁻¹ is required for φ and s for φ⁻¹. φ is now described in detail below. From

$$f ( x ) = {x}^{2 g + 1} + {\sum }_{i = 0}^{2 g - 1} {f}_{i} {x}^{i}$$

we can get

$$\tilde{f} ( x ) = {x}^{2 g + 1} + {\sum }_{i = 0}^{2 g - 1} {s}^{2 i - 2 ( 2 g + 1 )} {f}_{i} {x}^{i} .$$

For general U(t) and V(t)

$$U ( t ) = {t}^{g} + {\sum }_{i = 0}^{g - 1} {U}_{i} {t}^{i} \qquad and \qquad V ( t ) = {\sum }_{i = 0}^{g - 1} {V}_{i} {t}^{i} ,$$

so that

$$\tilde{U} ( t ) = {t}^{g} + {\sum }_{i = 0}^{g - 1} {s}^{2 i - 2 g} {U}_{i} {t}^{i} \qquad and \qquad \tilde{V} ( t ) = {\sum }_{i = 0}^{g - 1} {s}^{2 i - ( 2 g + 1 )} {V}_{i} {t}^{i} .$$

In order to apply φ to the curve and to a base divisor [U(t), V(t)], s^{-k} is calculated for k=2, 3, . . . , 2g+1 in succession:

if k is even, then U_{g-k/2} and (if k is not equal to 2) f_{2g+1-k/2} is multiplied by s^{-k},

if k is uneven, V_{g-k/2} is multiplied by s^{-k}.

For k=2g+2, 2g+4, . . . , 2(2g+1), s^{-k} is calculated by repeated multiplication with s⁻² and f_{2g+1-k/2} multiplied by s^{-k}. Together these are 7g+1 multiplications; φ⁻¹ requires only 4g multiplications in K.

If the curve or at least one base field is established, there is also an implementatory trick which can be used to avoid calculating the inversion s⁻¹ of the element s on each use of the cryptographic device.

From the outset, during the initialisation phase of the cryptographic device a pair of field elements (s₀, s₀⁻¹) are generated at random together with several further such pairs (Kₗ,Kₗ⁻¹) and stored in the E²PROM.

Then before each cryptographic operation an index i is selected at random; thus (s₀, s₀⁻¹) is replaced in the E²PROM by (Kⁱ·s₀, Kₗ⁻¹·s₀⁻¹). The latter pair is then used instead of (s, s⁻¹) for curve randomisation in the current run of the cryptographic device.

To summarise it can be found that curve randomisation in uneven characteristic is an effective and efficient protective measure against attacks based on the method of differential power analysis. The total count of the necessary field operations in K is 11g+1. To summarise it can be found that curve randomisation in uneven characteristic is an effective and efficient protective measure against attacks based on the method of differential power analysis. The total count of the necessary field operations in K is 11g+1.

In practice this is comparable to the number of field operations for individual group operations and often far fewer than indicated by the formulae in

Tanja Lange, “Inversion-Free Arithmetic on Genus 2 Hyperelliptic Curves”, Cryptology ePrint Archive, Report 2002/147, 2002, http://eprint.iacr.org/,

Tanja Lange, “Weighted Co-ordinates on Genus 2 Hyperelliptic Curves”, Cryptology ePrint Archive, Report 2002/153, 2002, http://eprint.iacr.org/ and

J. Pelzl, T. Wollinger, J. Guajardo, C. Paar, “Hyperelliptic Curve Cryptosystems: Closing the Performance Gap to Elliptic Curves”.

The arguments presented above with regard to the general isomorphisms of curves also apply unchanged for the case discussed below, where K is a field of even characteristic. In this case however h(x)\tilde{h}(x) must no equal zero; in other words this means that the use of general isomorphisms is less efficient than in the case of uneven characteristic.

Instead of the general isomorphisms according to equation (4), it is assumed that b=0 and A(x)=0 and worked as in the case of uneven characteristic. The isomorphisms of the form
φ: (x,y) [symbol] (s⁻²x, s^{-(2g+1)}y) (12)
for general s ε F₂d\F₂ randomise all coefficients of the equation as follows:

$$\{ \begin{matrix}\tilde{h} ( x ) = {s}^{- ( 2 g + 1 )} h ( {s}^{2} x ) \\ \tilde{f} ( x ) = {s}^{- 2 ( 2 g + 1 )} f ( {s}^{2} x )\end{matrix} \qquad ( 13 )$$

As in the explicit description above of the very rapid curve randomisation achieved by means of an implementatory trick with a field K of uneven characteristic, also with an explicit description of the very rapid curve randomisation performed by means of an implementatory trick with a field K of even characteristic of

$$f ( x ) = {x}^{2 g + 1} + {\sum }_{i = 0}^{2 g - 1} {f}_{i} {x}^{i} \qquad und \qquad h ( x ) = {\sum }_{i = 0}^{g} {h}_{i} {x}^{i} ,$$

$$then$$

$$\tilde{f} ( x ) = {x}^{2 g + 1} + {\sum }_{i = 0}^{2 g - 1} {s}^{2 i - 2 ( 2 g + 1 )} {f}_{i} {x}^{i} \qquad und \qquad \tilde{h} ( x ) = {\sum }_{i = 0}^{g} {s}^{2 i - ( 2 g + 1 )} {h}_{i} {x}^{i}$$

and the formulae for Ũ, \tilde{V} again read

$$\tilde{U} ( t ) = {t}^{g} + {\sum }_{i = 0}^{g - 1} {s}^{2 i - 2 g} {U}_{i} {t}^{i} \qquad und \qquad \tilde{V} ( t ) = {\sum }_{i = 0}^{g - 1} {s}^{2 i - ( 2 g + 1 )} {V}_{i} {t}^{i} .$$

It can be concluded that no general isomorphisms of the type according to equation (4) are required but that those of the type according to equation (12) suffice to randomise efficiently all bits of the internal depictions.

The coefficients of \tilde{h}(x) are calculated from the co-efficients of h(x) in the same way as the coefficients of \tilde{V}(t): For k=3, 5, . . . , 2g+1 then V_{g-(k-1)/2} and h_{g(k-1)/2} are multiplied by s^{-k}; also h_{g} is multiplied by s⁻¹; this means that at most g+1 field operations more are required than in the case of uneven characteristic and all costs for the use of φ are 8g+2 multiplications after s has been selected and s⁻¹ calculated. The implementatory trick described above is not necessary here as the inversion is sufficiently fast in binary bodies.

Below a case distinction is examined for constant h and for non-constant h but defined via F₂:

For even characteristic it must be noted which problems occur if the coefficients of the defining equations are restricted for throughput reasons, where the simplest case should be considered that h(x) is a non-vanishing constant, since in equation (6) \tilde{h}(x) is also constant and non-vanishing.

Now however it is a known result of algebraic geometry that curves with equation y²+cy=f(x) with non-vanishing c and with deg f=5 supersingular (see Theorem 9 in S. D. Galbraith, “Supersingular curves in cryptography”, in C. Boyd (Ed.), ASIACRYPT 2001, “Lecture Notes in Computer Science”, Vol. 2248, Pages 495 to 513, Springer-Verlag, 2001) are not suitable for the cryptographic applications of interest here.

In contrast no hyperelliptic curve of genus g=3 in even characteristic is supersingular (see J. Scholten and H. J. Zhu, “Hyperelliptic curves in characteristic 2”, Inter, Math. Research Notices, 17 (2002), Pages 905 to 917), thus in principle curves with equation y²+cy=f(x) with non-vanishing c and with deg f=7 can be used on the condition that the expansion degree and group order are selected suitably.

Although in the work submitted by J. Pelzl, T. Wollinger, J. Guajardo and C. Paar “Hyperelliptic Curve Cryptosystems: Closing the Performance Gap to Elliptic Curves” gives a very rapid doubling formula for the case h(x)=1, the speed of divisor doubling can be substantially accelerated also if h(x) is a non-vanishing constant. If \tilde{h}(x)=s^{-(2g+1)}c=s⁻⁷c; this makes the case of curves of genus g=2 important.

In the case of a non-constant h, the coefficients of h(x) for reasons of speed are often selected in F₂ (see for example Tanja Lange, “Inversion-Free Arithmetic on Genus 2 Hyperelliptic Curves”, Cryptology ePrint Archive, Report 2002/147, 2002, http://eprint.iacr.org/, or Tanja Lange, “Weighted Co-ordinates on Genus 2 Hyperelliptic Curves”, Cryptology ePrint Archive, Report 2002/153, 2002, http://eprint.iacr.org/).

In this case of a non-constant h defined however over F₂, on the basis of equation (6) there is an equivalence with the following question: If h(x)ε F₂[x], for which b ε K and for which s ε K is h(x)=s^{-(2g+1)}h(s²(x−b))ε F₂[x]?

If r=(2g+1)−2 deg h, the leading co-efficient s^{-r} of \tilde{h}(x) is equal to one, since this leading co-efficient does not vanish; figure r is uneven, positive and <2g−1.

The cryptosystem must resist the index calculus attack by Gaudry (see P. Gaudry, “An algorithm for solving the discrete log problem on hyperelliptic curves”, in “Advances in Cryptology—Eurocrypt 2000”, Pages 19 to 34, “Lecture Notes” in Computer Science, Vol. 1807, Springer-Verlag, Berlin, Heidelberg, 2000) i.e. if g≦4; then r≦7, and for r there are only very few possible values; this makes its randomisation unnecessary.

Let the extension degree d=[K: F₂].

In this context it should be noted that for protection against attacks by Weil descent (see G. Frey, “How to disguise an elliptic curve (Weil descent)”, Talk at ECC '98, Waterloo, 1998 (slides available at http://www.cacr.math.uwaterloo.ca/conferences/1998/ecc98/slides.html); G. Frey, “Applications of arithmetical geometry to cryptographic constructions”, in “Finite fields and applications (Augsburg, 1999), Pages 128 to 161, Springer, Berlin, 2001) for extension degree d either a primary number p is selected in the order of ≧160/g or twice a primary number p in the order of ≧80/g.

The possible values of s are zero digits of irreducible factors of X^{r}−1, the degree divides by d. If d=p≧160/g≧40 (=preferred case), then s=1; if d=2p with p≧80/g≧20, s can only be a zero digit of a factor via F₂ of X^{r}−1 of degree 1 or 2. A rapid listing of such factors (it should be noted that r is uneven and ≦7) shows that either s=1 or r=3 and s²+s+1=0. If two coefficients of h(x) do not vanish, then always s=1.

If we now start from σ: α→α² as Frobenius automorphism of K/F2, then h(−b^{σj})=h(−b)^{σj}=h(−b)εF₂ for all j, because \tilde{h}(x)=h(x−b)ε F₂[x]. This means in other words that all conjugates of −b are under the Frobenius solutions of h(x)−h(−b)=0. If b is not an element of F₂ there are at least p≧80/g such conjugations, wherein the degree of h(x) is at most g≦4. For this reason b must be an element of F₂: there are only two possibilities for b, so randomisation of b is pointless.

It can thus be concluded that the relevant isomorphisms are of type
φ: (x,y) [symbol] (x,y+A(x))
where A(x)ε K[x] is of degree≦g .

In the sense of a hyperelliptic analogon, the situation here is similar to the situation described in the said work by M. Joye and C. Tymen in the randomisation of elliptic curves as only one of the two polynomials or only half of the co-ordinates can be randomised efficiently.

In fact the situation is even worse as according to equation (6) not all coefficients of f can be randomised to \tilde{f}, which increases the probability of a successful attack based on differential power analysis if curve randomisation alone is used.

To summarise, for the method described above of curve randomisation it can be found that this counter-measure for hyperelliptic curves of genus 2 in even characteristic

either is not adequate because two few co-efficients can be randomised,

or inhibits the power of the cryptographic system as the counter-measure uses the general isomorphisms according to equation (4) and leaves the co-efficients of h lying outside (4) F².

In the case of genus 3 the curves for equation y²+cy=f(x) and general isomorphisms can be used. In this case it is sufficient to fix in equation (4) b=0 and A(x)=0 and proceed as at the end of the previous description for the case of uneven characteristic in order to randomise all co-efficients reasonably.

In all further cases other techniques are recommended such as divisor randomisation which also works in uneven characteristic and which is explained below as a second embodiment example which can be implemented

in combination with the first embodiment example of curve randomisation or

independently of the first embodiment of curve randomisation In the technique of divisor randomisation the bits of the depiction of a reduced divisor which is normally the base element of the cryptosystem or an intermediate result of scalar multiplication are modified. The technique of divisor randomisation is used if a group element can be depicted in several different ways.

Noteworthy examples from the prior art are the projective co-ordinates on elliptic curves: two triplets (X, Y, Z) and (X′, Y′, Z′) represent the same point if a non-vanishing element s exists in the base field such that X=sX′, Y=sY′ and Z=sZ′. In the Jacobian co-ordinates (see D. V. Chudnovsky and G. V. Chudnovsky, “Sequences of numbers generated by addition in formal groups and new primality and factoring tests”, Advances in Applied Mathematics, 7 (1987), Pages 385 to 434), two triplets (X, Y, Z) and (X′, Y′, Z′) represent the same point if X=s²X′, Y=s³Y′ and Z=sZ′ with s ε K^{x}.

Recently alternative co-ordinate systems were proposed for hyperelliptic curves of genus 2. An inversion-free system by Miyamoto et al. (see Y. Miyamoto, H. Doi, K. Matsuo, J. Chao and S. Tsuji, “A fast addition algorithm of genus two hyperelliptic curve”, in Proceedings of SCIS 2002, IEICE Japan, Pages 497 to 502, 2002, in Japanese), which operates on the hyperelliptic correspondence of the projective co-ordinates for elliptic curves, has been extended and improved by Lange (see Tanja Lange, “Inversion-Free Arithmetic on Genus 2 Hyperelliptic Curves”, Cryptology ePrint Archive, Report 2002/147, 2002, http://eprint.iacr.org/), who also developed a correspondence of Jacobian co-ordinates, namely the weighted co-ordinates (see Tanja Lange, “Weighted Co-ordinates on Genus 2 Hyperelliptic Curves”, Cryptology ePrintArchive, Report 2002/153, 2002, http://eprint.iacr.org/). No similar systems are known for genus 3.

The greater the genus of the curve, the smaller—for the same group order—is the base body, and hence the speed ratio of inversions to multiplications is smaller. This makes inversion-free formulae less attractive for genus 3 as one inversion is exchanged for many multiplications. However there are already efficient bit randomisation processes for curves of genus 3 both for uneven characteristic and for even characteristic.

In projective co-ordinates (genus 2) a divisor D with associated polynomial pair is shown as a quintuplet [U₁, U₀, V₁, V₀, Z] where
U(t)=t²+U₁t/Z+U₀/Z and V(t)=V₁t/Z+V₀/Z.

The divisor randomisation works as follows: A random s ε K^{x} is selected and the following conversion applied:
[U₁, U₀, V₁, V₀, Z]→[sU₁, sU₀, sV₁, sV₀, sZ].

In weighted co-ordinates a divisor D is shown by a sextuplet [U₁, U₀, V₁, V₀, Z₁, Z₂] where U(t)=t²+U₁t/Z₁²+U₀/Z₁² and V(t)=V₁t/(Z₁³Z₂)+V₀/(Z₁³Z₂).

To make a base divisor or an intermediate calculation invisible, two elements s₁, s₂ in K^{x} are selected at random and the following transformation performed:
[U₁, U₀, V₁, V₀, Z₁, Z₂]→[s₁²U₁, s₁²U₀, s₁³s₂V₁, s₁³s₂V₀, s₁Z₁, s₂Z₂]

If the additional optional co-ordinates
z₁=Z₁², z₂=Z₂², z³=Z₁·Z₂ and z₄=z₁·z₂=z₃²

are used, these additional optional co-ordinates must also be updated; the quickest way of updating is to recover them from the images of Z₁ and Z₂ by three quadrations and a multiplication.

The two measures proposed according to the invention namely the measure of curve randomisation (=first embodiment example) and the measure of divisor randomisation (=second embodiment example) each individually and in combination reinforce the hyperelliptic cryptosystems against differential power analysis. Both the technique of curve randomisation and the technique of divisor randomisation are simple to introduce and only have a negligible effect on the throughput.

The method according to the first embodiment example i.e. curve randomisation, transports the scalar multiplication in the Jacobian variation into a randomly selected isomorphic group. Scalar multiplication is performed in this second group and the result of the scalar multiplication returned to the first group. The method of curve randomisation can be applied to curves of any genus.

The method according to the second embodiment example, i.e. divisor randomisation, is a hyperelliptic variant of Coron's third counter-measure. Divisor randomisation can only be applied in curve families of which the co-ordinate systems are known for group operations in the associated Jacobian variation which correspond to the elliptic projective or Jacobian.

The two counter-measures described above for defence of attacks based on differential power analysis on implementations of hyperelliptic cryptosystems can be used independently of each other or simultaneously.

### REFERENCE LIST

C hyperelliptic curve

\tilde{C} transformed hyperelliptic curve

D divisor, in particular reduced divisor

g genus

J Jacobian variation

K field, in particular finite field

n scalar

s element, in particular non-vanishing element

s₁ first element, in particular non-vanishing first element

s₂ second element, in particular non-vanishing second element

t variable

φ depiction

φ⁻¹ inverse depiction

[U₁, U₀, V₁, V₀, Z] quintuplet

[sU₁, sU₀, sV₁, sV₀, sZ] converted quintuplet

[U₁, U₀, V₁, V₀, Z₁, Z₂] sextuplet

[s₁²U₁, s₁²U₀, s₁³s₂V₁, S₁³s₂V₀, S₁Z₁, S₂Z₂] converted sextuplet

1. A method for defence against at least one attack made by means of differential power analysis in at least one hyperelliptic cryptosystem, in particular in at least one hyperelliptic public key cryptosystem, which is given by at least one hyperelliptic curve of any genus over a finite field in a first group, where the hyperelliptic curve is given by at least one coefficient, characterised in that the hyperelliptic curve and/or at least one element of the first group, in particular at least one in particular reduced divisor and/or at least one intermediate result of a scalar multiplication is randomised.

2. A method as claimed in claim 1, characterised in that the bits of the operand to be processed and/or encoded in the hyperelliptic cryptosystem are represented by the hyperelliptic curve, in particular by at least one co-efficient of the hyperelliptic curve, and/or by at least one base element of the cryptosystem, such as by at least one in particular reduced divisor and/or at least one intermediate result of a scalar multiplication.

3. A method as claimed in claim 1, characterised in that at least one scalar multiplication in the Jacobian variation of the hyperelliptic curve takes place in a second group different from the first group and isomorphic in relation to the first group, in particular selected at random.

4. A method as claimed in claim 3, characterised by the following steps:
transformation of the Jacobian variation of the hyperelliptic curve by means of at least one depiction, in particular by means of at least one K-isomorphism, into the Jacobian variation of the transformed hyperelliptic curve;
multiplication of the Jacobian variation of the transformed hyperelliptic curve with at least one scalar; and
back transformation of the Jacobian variation multiplied by the scalar (n) of the transformed hyperelliptic curve )by means of the depiction inverse to the depiction in a Jacobian variations of the hyperelliptic curve multiplied by scalars,
where
the depiction corresponds to the transition from the first group to the second group
the inverse depiction corresponds to the transition from the second group to the first group.

5. A method as claimed in claim 1, characterised by the following steps:
depiction of at least one in particular reduced divisor with associated polynomial pair as at least one quintuplet in projective co-ordinates,
where U(t)=t²+U₁t/Z+U₀/Z and V(t)=V₁t/Z+V₀/Z;
selection, in particular random selection, of at least one non-vanishing element from the field; and
conversion of the quintuplet by means of a selected element into the converted quintuplet.

6. A method as claimed in claim 1, characterised by the following steps:
depiction of at least one in particular reduced divisor with associated polynomial pair as at least one sextuplet a projective co-ordinates,
where U(t)=t²+U₁t/Z₁²+U₀/Z₁² and V(t)=V₁t/(Z₁³Z²)+V₀/(Z₁³Z₂);
selection, in particular random selection, of at least two non-vanishing elements
from the field; and
conversion of the sextuplet by means of a selected elements
into the converted sextuple.

7. A method as claimed in claim 1, characterised in that the method is implemented on at least one microprocessor in particular allocated to at least one chip card and/or in particular to at least one smart card.

8. A microprocessor working according to a method as claimed in claim 1.

9. A device, in particular a chip card and/or in particular a smart card, with at least one microprocessor as claimed in claim 8.

10. Use of a method as claimed in claim 1 and/or at least one microprocessor as claimed in claim 8 and/or at least one device in particular at least one chip card and/or at least one smart card as claimed in claim 9 in the defence against at least one attack made by means of differential power analysis on at least one hyperelliptic cryptosystem, in particular at least one public key cryptosystem.
